(19) United States
(12) Patent Application Publication
(10) Pub. No.: US 2009/0284024 A1
(43) Pub. Date: Nov. 19, 2009

(54) LOCK ASSEMBLY

(75) Inventors: Peter DeLeonardis, Burlington, CT (US); Ronald R. Laliberte, Prospect, CT (US)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 12/467,154

(22) Filed: May 15, 2009

Related U.S. Application Data
(60) Provisional application No. 61/053,271, filed on May 15, 2008.

(51) Int. Cl. E05C 1/04; E05B 65/08; E05B 65/36

(52) U.S. Cl. 292/145; 70/95; 70/262

(57) ABSTRACT

A door lock assembly for a pair of sliding doors that slide between open and closed positions. The door lock assembly comprising a pair of latches, each of the pair of latches configured to latch an associated one of the pair of sliding doors. Each of the sliding doors has an associated lock engagement structure. Each of the latches is cooperable with the associated lock engagement structure such that the lock engagement structure moves the latch from an unlocked configuration to a locked configuration only when the door(s) carrying the lock engagement structure is (are) moved to a fully closed position.

This application claims the benefit of U.S. Provisional Application No. 61/053,271 filed May 15, 2008.

### FIELD OF THE INVENTION

The present invention relates to lock assemblies, and more in particular to a lock assembly configured to secure doors such as slidable doors, or sliding doors against unauthorized entry.

### BACKGROUND OF THE INVENTION

Sliding doors are commonly used in commercial buildings, airports, and the like. Such sliding doors typically have one or more doors carried in a surrounding frame (e.g., made of metal or wood) adapted for sliding movement back and forth upon a track or a rail. These sliding doors provide convenient access for ingress and egress. For some applications it is desirable to secure these sliding doors with a lock to prevent unauthorized entry. In other applications, it is desirable to have sliding doors with sensors that determine if the doors are closed and locked and provide a warning signal if the doors are not closed and/or locked.

### SUMMARY OF THE INVENTION

One embodiment of the invention relates A door lock assembly for a pair of sliding doors that slide between open and closed positions, the door lock assembly comprising a pair of latches, each of the pair of latches configured to latch an associated one of the pair of sliding doors, each sliding door having an associated lock engagement structure, each latch being cooperable with the associated lock engagement structure such that the lock engagement structure moves the latch from an unlocked configuration to a locked configuration and when the door carrying the lock engagement structure is moved to a fully closed position; and a latch sensor comprising a sensor member connected to at least one of the latches, the sensor determining when both latches are in a locked configuration with respect to the lock engagement structures, the latch sensor outputting a signal in response to such determination.

Another embodiment of the invention relates to A door lock assembly for a pair of sliding doors that slide between open and closed positions, the door lock assembly comprising a pair of latches, each of the pair of latches configured to latch an associated one of the pair of sliding doors, each sliding door having an associated lock engagement structure, each latch being cooperable with the associated lock engagement structure such that the lock engagement structure moves the latch from an unlocked configuration to a locked configuration and when the door carrying the lock engagement structure is moved to a fully closed position, a latch sensor arranged to determine when both latches are in a locked configuration with respect to the lock engagement structure; and a door close sensor arranged to determine when at least one of the doors is in a fully closed position.

Another embodiment of the invention relates to A door lock assembly for a pair of sliding doors that slide between open and closed positions, the door lock assembly comprising a pair of latches, each of the pair of latches configured to latch an associated one of the pair of sliding doors, each sliding door having an associated lock engagement structure, each latch being cooperable with the associated lock engagement structure such that the lock engagement structure moves the latch from an unlocked configuration to a locked configuration and when the door carrying the lock engagement structure is moved to a fully closed position; a solenoid release mechanism operatively connected with the latches, the solenoid being electrically operated to move the latches from the lock configuration to the unlocked configuration; and a manual release mechanism operatively connected with the latches, the manual release mechanisms being manually operable to move the latches from the locked configuration to the unlocked configuration.

Another embodiment of the invention relates to a lock assembly for a slidable door, the slidable door comprising a rod protruding vertically from an upper surface of the slidable door, the lock assembly comprising at least one cam configured to rotate about an axis parallel to the rod, the cam being contoured to engage the rod and releasably secure the rod against a surface, and a pin configured to engage the cam and releasably lock the cam in a stationary position when the cam secures the rod against the surface.

Another embodiment of the invention relates to a system comprising at least one sliding door having an engagement structure; and a lock assembly comprising at least one latch assembly configured to cooperate with the engagement structure such that the lock engagement structure moves the latch from an unlocked configuration to a locked configuration when the door carrying the lock engagement structure is moved to a fully closed position; and a sensor that senses whether the door is closed and/or the latch is not is locked.

Another embodiment of the invention relates to a method of locking a sliding door comprising sliding a door having an engagement structure, rotating latching mechanism from an open position to a closed position with the rod, and locking the latching mechanism in the closed position with a locking mechanism, sensing with a single sensor when the sliding door is fully closed and the latching mechanism is locked.

### BRIEF DESCRIPTION OF THE DRAWINGS

The novel features that are considered characteristic of the invention are set forth with particularity in the appended claims. The invention itself, however, both as to its structure and operation together with the additional objects and advantages thereof are best understood through the following description of the preferred embodiment of the present invention when read in conjunction with the accompanying drawings, wherein:

FIG. 1 is a front view of an embodiment a lock assembly of the present invention mounted on a door frame;

FIG. 2 is a perspective view of an embodiment of a lock assembly of the invention;

FIG. 3 is a top view of an embodiment of a lock assembly of the invention;

FIG. 4 is a cross sectional view of the embodiment illustrated in FIG. 3 through the line CC;

FIG. 5. is a front view of an embodiment of a lock assembly of the invention;

FIG. 6 is a cross sectional view of the embodiment illustrated in FIG. 5 through the line AA;

FIG. 7 is a is a back view of an embodiment of a lock assembly of the invention;

FIG. 8 is a cross sectional view of the embodiment illustrated in FIG. 5 through the line BB;

FIG. 9 is an exploded view of an embodiment of a lock assembly of the invention; and

FIG. 10 is a schematic illustration of the operation of an embodiment of a lock assembly of the invention with: (a) the cams closed and locked, (b) the switch at the break point, the cams still closed and locked, (c) the cams closed but unlocked, and (d) the cams unlocked and open.

FIG. 11 is a perspective view of an alternate embodiment of the embodiment illustrate in FIG. 2.

### DETAILED DESCRIPTION

Embodiments of the present invention include a door lock assembly for a pair of sliding doors that slide between open and closed positions. Alternatively, the door lock assembly may be used with a single sliding door. For a pair of doors, the door lock assembly comprises a pair of latches in which each of the pair of latches is configured to latch one of the pair of sliding doors. In one embodiment each of the sliding doors includes an associated lock engagement structure cooperable with an associated lock engagement structure of the door lock assembly. In one embodiment the lock engagement structure moves the latch from an unlocked configuration to a locked configuration only when the door(s) carrying the lock engagement structure is (are) moved to a fully closed position.

In some embodiments, the door lock assembly includes a latch sensor. In one embodiment, the latch sensor includes a sensor member connected to at least one of the latches. In one embodiment the latch sensor is configured to determine if at least one of the latches is in a locked position. In another embodiment, the sensor can be configured to determine when both latches are in a locked configuration with respect to the lock engagement structures. In one embodiment, the latch sensor is configured to output a signal in response to such determination. In an alternative embodiment, the door lock assembly includes a latch sensor and a door close sensor. The door close sensor is configured to determine when at least one of the doors is in a fully closed position. In one embodiment, the door lock assembly is configured to send a signal when one or both of the latch sensor or door close sensor sense that one of the doors is either unlocked or not fully closed.

The door lock assembly may further include a solenoid release mechanism operatively connected with the latches. The solenoid release mechanism may include a solenoid 7, a chassis 49, a solenoid shaft 7a, and a reciprocating member 50. Other components may also be included in the solenoid release mechanism. The solenoid is electrically operated to move the latches from the lock configuration to the unlocked configuration. The door lock assembly may also include a manual release mechanism operatively connected with the latches. The manual release mechanism is configured to be manually operable to move the latches from the locked configuration to the unlocked configuration. In this manner, the door lock assembly may be operated to unlock the doors during a power failure or if the solenoid fails.

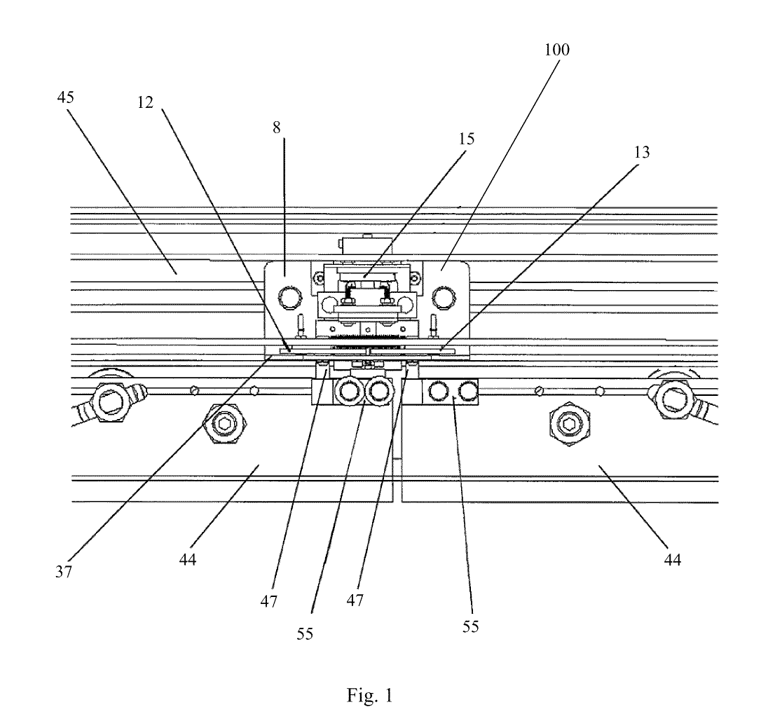

FIGS. 1-9 illustrate a lock assembly 100 for a pair of doors 44 according to one or more embodiments of the invention. Although, the lock assembly 100 is described with respect to the pair of doors 44, such as a bi-parting sliding door, it is contemplated that the lock assembly 100 (or an appropriately modification thereof that eliminates certain parts) may be used for positively latching a single door 44, such as a single sliding door or door 44.

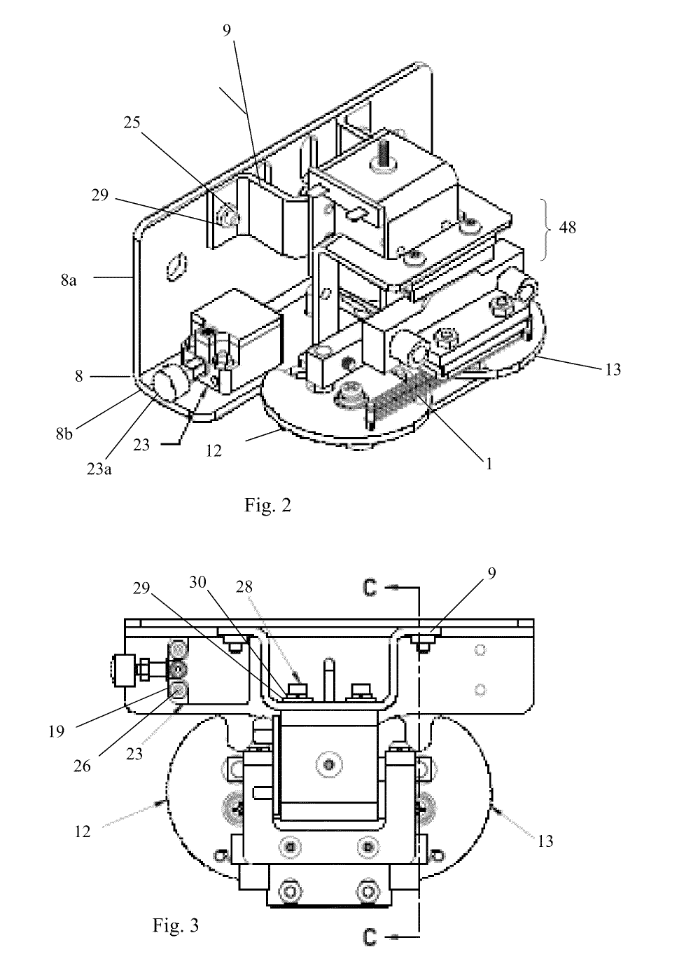

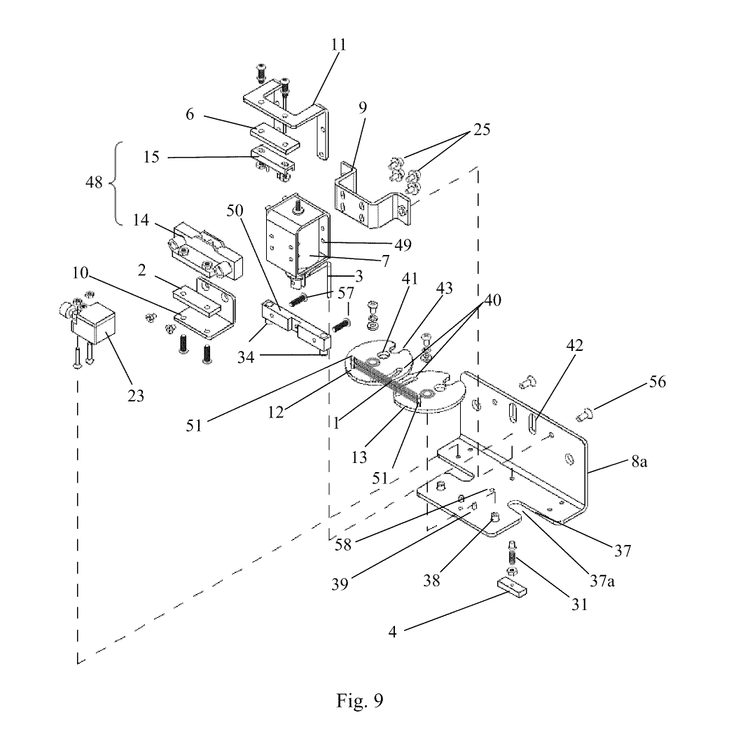

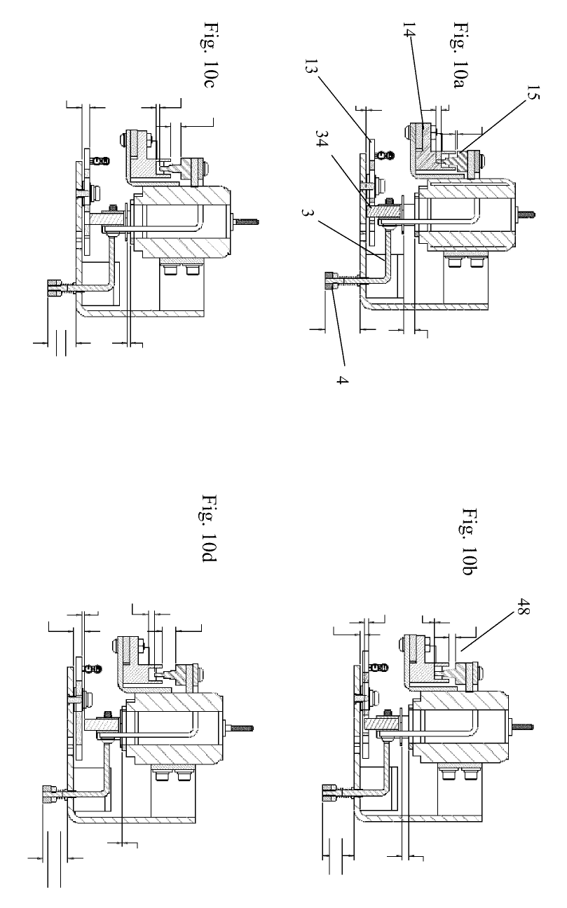

In one embodiment, the pair of doors 44 (reference 44 illustrates a partial front view of two upper doors) are carried in a surrounding frame 45 and are adapted for sliding movement back and forth upon a track or a rail (not shown) in the frame 45 (FIG. 1). The lock assembly 100 may be attached to the frame 45 using a solenoid lock base bracket 8. In one embodiment, the solenoid lock base bracket 8 is a generally an L-shaped plate member, having a vertical portion 8a and a horizontal portion 8b (FIG. 2). The vertical portion 8a of the solenoid lock base bracket 8 includes mounting holes 42 and fasteners (FIG. 9). The lock assembly 100 may be mounted to the door frame 45 via the mounting holes 42. In some embodiments, the lock assembly 100 may be mounted to the door frame 45 with bolts or screws. Other means of attaching the lock assembly 100, however, may be used. For example, the lock assembly 100 may be affixed to the door frame by welding, brazing or gluing. The horizontal portion 8b of the solenoid lock base bracket 8 may include cam mounting rods 38 and travel stop pins 39, discussed in more detail below.

In one embodiment, each door 44 includes a lock engagement structure 47 that is arranged to be engaged with the lock assembly 100 to lock the door in a fully closed position. In one embodiment, the lock engagement structures 47 extend vertically above an upper surface of the door 44. The lock engagement structure 47 may take the form of a rod, pin, plate, or any other suitable structure. The lock engagement structure 47 may be fastened to a top portion of each door 44 with a bracket 55. The brackets 55 are generally attached to the top or the back of the doors 44 using screws, bolts, pins or other attachment mechanism as would be appreciated by one skilled in the art. The horizontal portion 8b of the solenoid lock base bracket 8 defines a channel 37a (FIG. 9) within which the lock engagement structures 47 are releasably secured when the rods 47 are engaged within the notches 43 of cams 12, 13 respectively. The cams 12, 13 with notches 43 act as latches. That is, the cams 12, 13 with notches 43 secure rods 47, preventing the doors 44 from opening. In other embodiments of the invention, other structures may be used as latches.

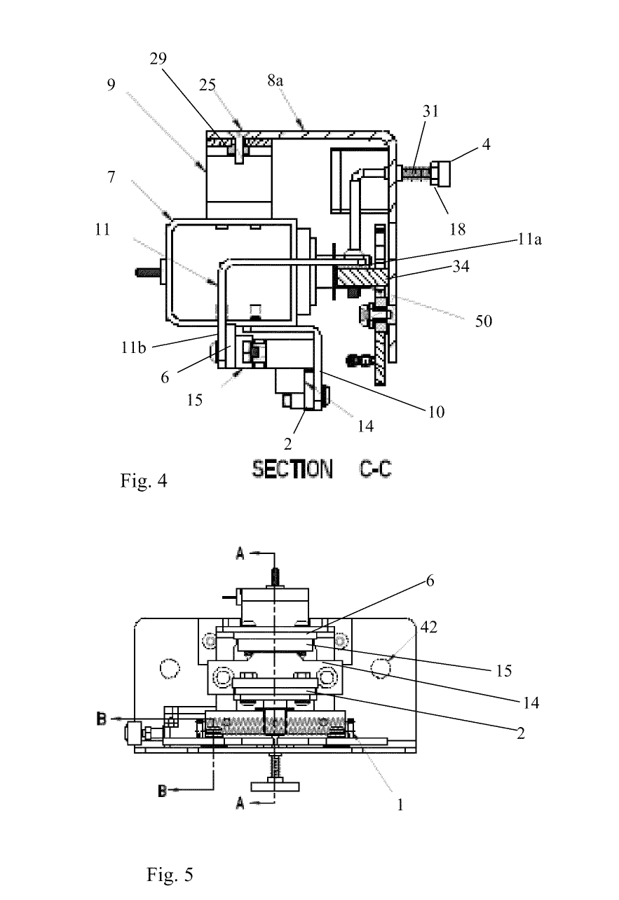

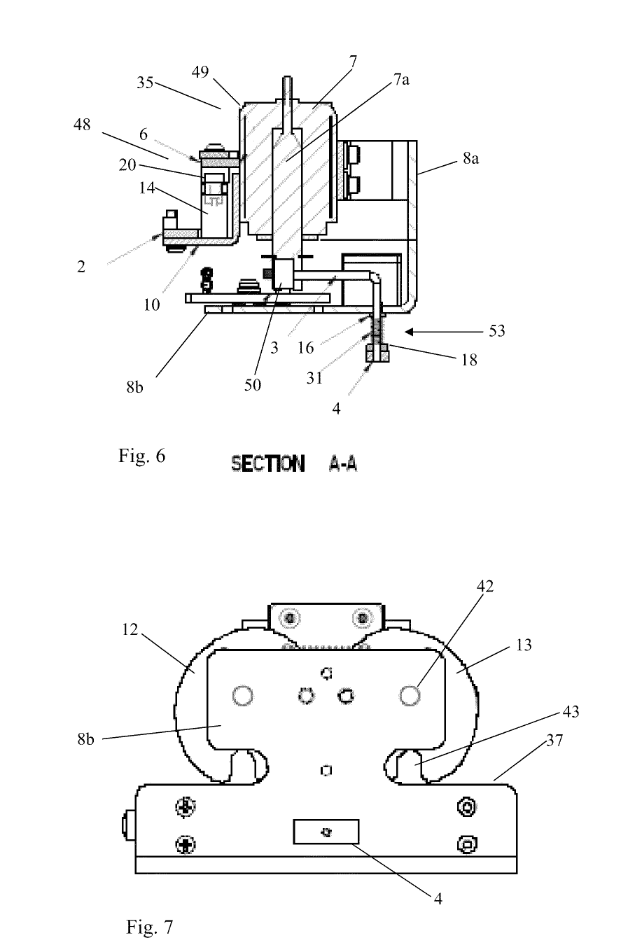

Also included in this embodiment is a solenoid mounting bracket 9 (FIG. 2) that is affixed to the vertical portion 8a of the solenoid lock base bracket 8. In one embodiment, a solenoid 7 is affixed to the solenoid lock base bracket 8 with the solenoid mounting bracket 9 (FIG. 6). In one embodiment, the solenoid mounting bracket 9 may be affixed to the vertical portion 8a of the solenoid lock base bracket 8 with screws 25 (FIG. 4). Optionally, a flat washer 29 may also be used in affixing the solenoid mounting bracket 9 to the vertical portion 8a of the solenoid lock base bracket 8. In alternative embodiments, the solenoid mounting bracket 9 may be affixed to the vertical portion 8a of the solenoid lock base bracket 8 with nuts and bolts. In still other embodiments, affixing may be accomplished by welding, brazing, gluing, or by any other suitable means of attaching one bracket to another.

In an optional embodiment, a door close sensor 23 may be attached to the horizontal portion 8b of the solenoid lock base bracket 8 (FIG. 2). The door close sensor 23 is configured to detect if a door 44 is closed. In one embodiment, the sensor 23 is an electromechanical contact switch with an activation button 23a. The door close sensor 23 is configured such that a contact structure, such as a flag, is affixed to the door to contact the button 23a to trigger the sensor when the door 44 is in a fully closed position. In one embodiment, the flag is a plate and the door close sensor 23 is a positive break sensor. A positive break sensor includes the button 23a or a plunger that, when depressed, sends a signal. When the door 44 is in the fully closed position, the plate (not shown) depresses the button 23a or plunger, signaling that the door 44 is close.

In one embodiment, the door close sensor 23 is attached to the horizontal portion 8b of the solenoid lock base bracket 8 with screws 26 and hex nuts 19 (FIG. 3). Other attachment means, however, may be used. The door close sensor 23 is operatively (electronically) connected to the solenoid 7. In alternative embodiments, the door close sensor 23 may be mounted in other locations. For example, the door close sensor 23 may be mounted on the vertical portion 8a of the solenoid lock base bracket 8 or on an opposite side of the horizontal portion 8b of the solenoid lock base bracket 8 (FIG. 11). In still another embodiment, the lock assembly 100 may include two door close sensors, one on either side of the solenoid lock base bracket 8, each door close sensor 23 configured to detect one of the doors 44.

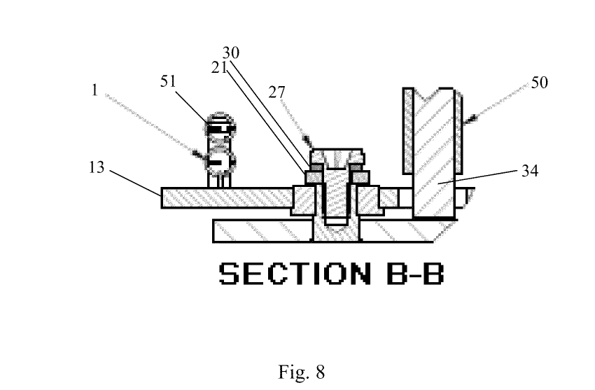

Attached to the horizontal portion 8b of the solenoid lock base bracket 8 is a pair of cams 12, 13. The pair of cams 12, 13 rotate in opposite directions with respect to each other and are rotatably attached to the horizontal portion 8b of the solenoid lock base bracket 8 via cam mounting rods 38 (FIGS. 8, 9). The cam mounting rods 38 define an axis of rotation that is parallel to the axis of the rods 47. In one embodiment, the cams 12, 13 are attached to the solenoid lock base bracket 8 with screws 27. In one embodiment attachment of the cams 12, 13 to the solenoid lock base bracket 8 comprises a flat washer 21 and a lock washer 30.

The pair of cams 12, 13 are configured to rotate between a locked position and an unlocked position. Both cams 12, 13 include a curved slot 40 (FIG. 9). As the cams 12, 13 rotate, the curved slot 40 rotates about travel stop pins 39 which are attached to or integral with the horizontal portion 8b of the solenoid lock base bracket 8. The travel stop pins 39 prevent the cams 12, 13 from rotating beyond a desired position, such as the open position.

In addition to the curved slots 40, the cams 12, 13 include a notch 43 in their periphery. The notch 43 is sized to accept the lock engagement structures 47. When the cams 12, 13 are in the open position, the notches 43 are aligned to receive the door rods 47 as the doors 44 slide toward a closed position. As the doors 44 reach the closed position, the lock engagement structures 47 enter the notch 43 of the cams 12, 13 and force the cams 12, 13 to rotate to a closed position in which the lock engagement structures 47 are captured in channels 37a of the horizontal portion 8b.

When the cams 12, 13 rotate into the closed position, the lock engagement structures 47 are secured against the surface 37 of the horizontal portion 8b of the solenoid lock base bracket 8 (FIG. 9). Then, a pair of locking pins 34 engage the cams 12, 13 through locking holes 41 in each cam 12, 13, preventing the cams 12, 13 from rotating (FIG. 8) out of the locked position. In this manner, the cams 12, 13 are in a closed and locked position. In one embodiment, the locking pins 34 automatically and releasably lock each cam 12, 13 in a locked or stationary position when the locking pins 34 are aligned with holes 41. In one embodiment, this automatic feature can be achieved by use of a compression spring 31 (FIG. 6). When the cams 12, 13 are in an open position, the locking pins 34 are pressed against the surface of the cams 12, 13 due to the spring energy in the compression spring 31. When the locking holes 41 in the cams 12, 13 rotate under the locking pins 34, the compression spring 31 (FIG. 6), which is compressed between the horizontal portion 8b and a release block 4, causes the locking pins 34 to drop into the locking holes 41.

The lock assembly 100 further includes a pin release assembly 35 (FIG. 6). The pin release assembly 35 comprises a solenoid 7 and reciprocating member 50. The locking pins 34 are attached to the reciprocating member 50 and are configured to move up and down with the reciprocating member 50. The reciprocating member 50 is configured to move down to engage the locking pins 34 within the holes 41 in the cams 12, 13 when the cams 12, 13 are in locked position, and to move up to disengage the locking pins 34 with the cams 12, 13 when the pin release assembly 35 is operated.

The pin release assembly 35 is configured to disengage each locking pin 34 from the cams 12, 13, thereby allowing each cam 12, 13 to automatically rotate into the unlocked position. That is, when the locking pins 34 are removed from the locking holes 41, contracting tension in a pair of cam springs 1 causes the cams 12, 13 to rotate into the open position (such that the notches 43 align with channels 37a and the lock engagement members 47 are free to escape from channels 37a). The pair of cam springs 1 are connected to a pair of spring pins 51 located on the cams 12, 13 (FIG. 9). The cam springs 1 stretch when the engagement members 47 are forced against the cams 12, 13 within notches 43 to lock the engagement members 47 and relax causing the cams 12, 13 to rotate between the locked and the unlocked positions, when the pins 34 are released. That is, the cam springs 1 are configured to move from an original position in which the cam springs 1 are relaxed to an extended position in which the cam springs are stretched as the cams 12, 13 move from the unlocked to the locked position, respectively. When the locking pins 34 are disengaged from the locking holes 41, the stored energy in the cam springs 1 cause the cams 12, 13 to rotate from the closed position to the open position.

As noted above, in one embodiment, the pin release assembly 35 comprises a solenoid 7. The solenoid 7 is an electromechanical device that utilizes magnetic energy to linearly move its solenoid shaft 7a (FIG. 6), which is connected to the reciprocating member 50, to disengage locking pins 34 from cams 12, 13 (FIG. 9). In one embodiment, the pin release assembly 35 may be at least partially housed within a chassis 49. The chassis 49 for the pin release assembly 35 may connected to the vertical portion 8a of the solenoid lock base bracket 8 via the solenoid mounting bracket 9. In one embodiment, the chassis 49 may be attached to the solenoid mounting bracket 9 with screws 28 (FIG. 3). Optionally, a flat washer 29 and a lock washer 30 may also be used in the attachment of the chassis 49 to the solenoid mounting bracket 9.

The lock assembly 100 further includes a lock (or latch) sensor 48 (FIG. 2, FIG. 6), which is a sensor that senses whether the reciprocating member 50 (and pins thereon) is in the locked position. The lock sensor 48 provides a locked indication only when both of the doors 44 are closed and in a locked position. The lock sensor 48 is formed by positive double-break switch 14 and a contact bridge 15. The closed and locked status of the pair of doors 44 is provided when the normally-open contact bridge 15 is closed or engaged with the positive double-break switch 14. This occurs when both lock engagement structures 47 have rotated the cams 12, 13 into a fully locked position and the locking pins 34 have dropped down into locking holes 41. In one embodiment, the lock sensor 48 may be configured to send a signal when the doors 44 are in a fully closed position and the reciprocating member 50 is in the locked position. In an alternative embodiment, the lock sensor 48 may be configured to send a signal when at least one of the doors 44 is not in a fully closed position and/or the reciprocating member 50 is not in a fully locked position.

The reciprocating member 50 is connected by fasteners 57 to one end 11a of a switch mount bridge bracket 11 (FIG. 4). Connected to an upper cross member 11b of the switch mount bridge bracket 11 is the contact bridge 15. An optional spacer 6 between the contact bridge 15 and the switch mount bridge bracket 11 may also be included. The positive double-break switch 14 is connected to the solenoid chassis 49 via switch mount bracket 10. An optional spacer 2 between the positive double-break switch 14 and the switch mount bracket 10 may also be included. The positive double-break switch 14 stays stationary as it is attached to the solenoid chassis 49 via a switch mount bracket 10 (FIG. 6). The contact bridge 15, however, moves up and down with the reciprocating member 50. As the contact bridge 15 moves up and down with the reciprocating member 50, an electrical connection with the positive double-break switch 14 opens and closes, respectively. When cams 12, 13 are in an unlocked position, the contact bridge 15 is positioned out of electrical connection with the positive double-break switch 14, thereby indicating that lock assembly 100 is unlocked. When cams 12, 13 are rotated into a locked position and the reciprocating member 50 moves into the locked position, the contact bridge 15 forms a closed electrical connection with the positive double-break switch 14, thereby indicating that the doors 44 are closed and the lock assembly 100 is locked.

As shown in FIG. 6, the positive break switch 14 is connected to the pin release chassis 49 using a switch mount bracket 10. In one embodiment, the switch mount bracket 10 comprises an L-shaped member. In one embodiment, a threaded screw 20 is used to connect the positive double-break switch 14 to one end of the switch mount bracket 10. At the other end, the switch mount bracket 10 is connected to the pin release chassis 49 using any attachment mechanism, such as screws, bolts, pins, or the like. In one embodiment, a pair of threaded screws and nuts 20 are used to connect the bridge switch 15 to one end of the switch mount bridge bracket 11 (FIG. 4). At the other end, the switch mount bridge bracket 11 is connected to the reciprocating member 50 using any attachment mechanism, such as screws, bolts, pins or the like.

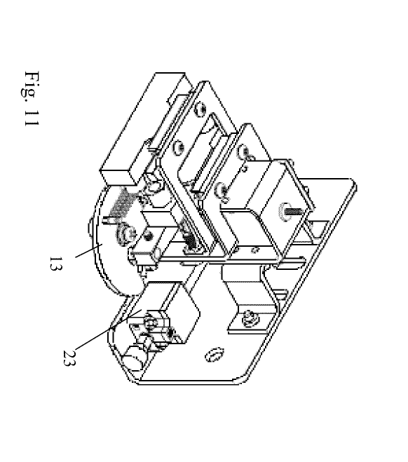

FIGS. 10a-10d illustrate the operation of a lock assembly 100 according to an embodiment of the invention. FIG. 10a illustrates the cams 12, 13 in closed and locked position. Unlocking of cams 12, 13 is achieved by operating the pin release assembly 35 as described earlier. When the pin release assembly 35 is operated, the pin release assembly 35 lifts the reciprocating member 50 and the locking pins 34 attached with the reciprocating member 50. At the point illustrated in FIG. 10b, the cams 12, 13 are still in the closed and locked position but the lock sensor 48 is at the break point. That is, the contact bridge 15 has been lifted to the point at which the electrical connection with the positive double-break switch 14 is broken.

When the locking pins 34 are lifted by the pin release assembly 35, the locking pins 34 disengage the locking holes 41 located on the cams 12, 13 allowing the cams 12, 13 to rotate freely. In FIG. 10c, the cams 12, 13 are unlocked but still in the closed position. In FIG. 10d, the cams 12, 13 are unlocked and have rotated into the open position. That is, as the pair of doors 44 move out of the fully closed position, the rods 47 and springs 1 cause the cams 12, 13 to rotate into the unlocked position. The lock engagement structures 47 attached to the doors 44 are now free to move, allowing the doors 44 to open.

The operation of locking the cams 12, 13, in the unlocked position will now be explained. When the cams 12, 13 are in the unlocked position, the travel stop pins 39 engage with one end of the slots 40. This prevents the cams 12, 13 from rotating beyond the unlocked position and places the notch 43 in the periphery of the cams 12, 13 in a position to receive the rods 47. When the cams 12, 13 are in the open position, the cam springs 1 are in a relaxed, preloaded position. When the cams 12, 13 are in the open position, each of the locking pins 34 is configured to separately rest against the flat surface of cams 12, 13.

As the cams 12, 13 move from the open position to the closed position, the cam springs 1 gradually move from the relaxed position to an extended position as shown in FIG. 2. Once the cams 12, 13 move to the fully closed position as shown in the FIG. 2, the locking pins 34 attached to the reciprocating member 50 (as shown in FIG. 3) pass through the locking holes 41 on the cams 12, 13, thereby locking cams 12, 13. In the locked position, the cams 12, 13 secure the rods 47 against the surface 37 and thus prevent the pair of doors 44 from opening.

In one embodiment, as shown in FIGS. 4, 5 and 6, in addition to unlocking via electrically operated solenoid 7, manual unlocking is also possible. Manual unlocking of the locking pins 34 may be achieved by using a manual release 3. In one embodiment, manual release 53 includes a manual release block 4 connected to the reciprocating member 50 via a manual release rod 3. The manual release rod 3 has an L shaped configuration, with one leg extending through a hole 58 so that an end thereof is connect with release block 4, and has another leg extending through a connecting hold in the solenoid shaft 7a (which shaft 7a is connected to reciprocating member 50). A hex nut 18 may be used to connect the manual release rod 3 with the manual release block 4. The compression spring 31 is compressed between a bottom surface of the horizontal portion 8b of the solenoid lock base bracket and the release block 4. The tension in the spring 31 serves to bias the locking pins 34 towards the locking direction by pulling downward on the release rod 3. Manual unlocking is achieved by pushing the manual release block 4 and the manual release rod 3 against the bias of compression spring 31, which in turn lifts the reciprocating member 50 and the locking pins 34 attached to the reciprocating member 50, to disengage the locking pins 34 from the holes 41 in the cams 12, 13 allowing the cams 12, 13 to rotate out of the fully closed position. Once the locking pins 34 are disengaged from cams 12, 13, cams 12, 13 are able to rotate, thereby allowing rods 47 to be moved away from each other. That is, allowing for the separation and opening of doors 44.

In one embodiment, the door close sensor 23 and the door lock sensor 48 may be used in tandem. For example, in one embodiment, both sensors 23 and 48 provide an output signal when the door close sensor 23 detects that the door or doors are fully closed (depending on whether it is desirable to detect on or both doors), and the door lock sensor 48 detects that the doors are locked. In one embodiment, a signal is sent when one of the sensors 23 or 48 indicate that the door (doors) are not fully closed or unlocked. That signal may be used, for example, to prevent or cause other operations. For example, if one of the sensors 23 or 48 detects that one or (both) of the doors are not fully closed or unlocked, a signal may be sent that will prevent operation of a rail car or train that is located behind the door or doors.

In another embodiment of the invention, the lock assembly 100 may be modified to be used with a single sliding door 44. In this embodiment, only one cam 12, 13 needs to be active. The other, idle cam 12, 13 may be pinned in the locked position and the reciprocating member 50 configured so that only the active cam 12, 13 moves up and down. In this manner, only one of the cams 12, 13 associated with one sliding door 44 is active.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

1. A door lock assembly for a pair of sliding doors that slide between open and closed positions, the door lock assembly comprising:
a pair of latches, each of the pair of latches configured to latch an associated one of the pair of sliding doors, each sliding door having an associated lock engagement structure, each latch being cooperable with the associated lock engagement structure such that the lock engagement structure moves the latch from an unlocked configuration to a locked configuration and when the door carrying the lock engagement structure is moved to a fully closed position; and
a latch sensor comprising a sensor member connected to at least one of the latches, the sensor determining when both latches are in a locked configuration with respect to the lock engagement structures, the latch sensor outputting a signal in response to such determination.

2. A door lock assembly for a pair of sliding doors that slide between open and closed positions, the door lock assembly comprising:
a pair of latches, each of the pair of latches configured to latch an associated one of the pair of sliding doors, each sliding door having an associated lock engagement structure, each latch being cooperable with the associated lock engagement structure such that the lock engagement structure moves the latch from an unlocked configuration to a locked configuration and when the door carrying the lock engagement structure is moved to a fully closed position;
a latch sensor arranged to determine when both latches are in a locked configuration with respect to the lock engagement structure; and
a door close sensor arranged to determine when at least one of the doors is in a fully closed position.

3. The door lock assembly of claim 2, wherein the door lock assembly is configured to send a signal when one or both of the latch sensor or door close sensor sense that one of the doors is either unlocked or not fully closed.

4. A door lock assembly for a pair of sliding doors that slide between open and closed positions, the door lock assembly comprising:
a pair of latches, each of the pair of latches configured to latch an associated one of the pair of sliding doors, each sliding door having an associated lock engagement structure, each latch being cooperable with the associated lock engagement structure such that the lock engagement structure moves the latch from an unlocked configuration to a locked configuration and when the door carrying the lock engagement structure is moved to a fully closed position;
a solenoid release mechanism operatively connected with the latches, the solenoid being electrically operated to move the latches from the lock configuration to the unlocked configuration; and
a manual release mechanism operatively connected with the latches, the manual release mechanisms being manually operable to move the latches from the locked configuration to the unlocked configuration.

5. The door lock assembly of claim 4, further comprising a latch sensor arranged to determine when both latches are in a locked configuration with respect to the lock engagement structure and a door close sensor arranged to determine when at least one of the doors is in a fully closed position

6. A lock assembly for a slidable door, the slidable door comprising a rod protruding vertically from an upper surface of the slidable door, the lock assembly comprising:
at least one cam configured to rotate about an axis parallel to the rod, the cam being contoured to engage the rod and releasably secure the rod against a surface; and
a pin configured to engage the cam and releasably lock the cam in a stationary position when the cam secures the rod against the surface.

7. The lock assembly of claim 6, wherein the pin automatically engages the cam and locks the cam in position when the cam is rotated into a locked position.

8. The lock assembly of claim 7 further comprising a pin release that pulls the pin away from the cam to release the cam from the locked position.

9. The lock assembly of claim 8, wherein the pin release comprises a solenoid.

10. The lock assembly of claim 6, wherein the lock assembly comprises a pair of cams.

11. The lock assembly of claim 10, wherein the pair of cams are connected to each other with at least one spring.

12. The lock assembly of claim 6, further comprising a sensor that senses whether the cam is locked.

13. The lock assembly of claim 12, further comprising a sensor that senses whether the door is closed.

14. The lock assembly of claim 6, further comprising a manually movable release operatively connected with the lock member, the release being manually movable to move the pin to unlock the cam.

15. A system comprising:
at least one sliding door having an engagement structure; and
a lock assembly comprising:
at least one latch assembly configured to cooperate with the engagement structure such that the lock engagement structure moves the latch from an unlocked configuration to a locked configuration when the door carrying the lock engagement structure is moved to a fully closed position; and
a sensor that senses whether the door is closed and/or the latch is not locked.

16. The system of claim 15, wherein the engagement structure comprises a rod protruding from the sliding door, the latch assembly comprises at least one cam configured to rotate about an axis parallel to the rod, the cam being contoured to engage the rod and releasably secure the rod against a surface, and a pin configured to engage the cam and releasably lock the cam in a stationary position when the cam secures the rod against the surface.

17. The system of claim 16, wherein the pin engages the cam and locks the cam in position when the cam is rotated into a locked position.

18. The system of claim 16, further comprising a pin release that pulls the pin away from the cam to release the cam from the locked position.

19. The system of claim 18, wherein the pin release is a solenoid.

20. The system of claim 15, wherein the lock assembly comprises a pair of cams.

21. The system of claim 20, wherein the pair of cams are connected with at least one spring.

22. The system of claim 16, wherein the sensor comprises a positive double break door contact.

23. The system of claim 15, wherein the cam comprises a curved slot configured to receive a pin to limit the amount of rotation of the cam.

24. The system of claim 16, wherein the sensor provides a warning if either the door is not fully closed or the latch is not locked.

25. A method of locking a sliding door comprising:
at least one sliding a door having an engagement structure;
rotating latching mechanism from an open position to a closed position with the rod; and
locking the latching mechanism in the closed position with a locking mechanism,
sensing with a single sensor when the sliding door is in the closed position and the latching mechanism is locked.

26. The method of claim 25, wherein the engagement structure comprises a rod protruding from the at least one sliding door, and the latching mechanism comprises a cam.

27. The method of claim 26, wherein locking the cam comprises inserting a pin through a hole in the cam.

28. The method of claim 25, further comprising sending a signal that the sliding door is in the closed position and the latching mechanism is locked.
